(19) United States
(12) Patent Application Publication
(10) Pub. No.: US 2017/0040008 A1
(43) Pub. Date: Feb. 9, 2017

(54) SOFT OUTER CASE FOR CARRYING TWO HARD-SHELL GUITAR CASES TOGETHER AS ONE TRAVEL ITEM

(71) Applicants: Thomas Ray Byrne, Kilmarnock, VA (US); Robert Wickens Thompson, Richmond, VA (US)

(72) Inventors: Thomas Ray Byrne, Kilmarnock, VA (US); Robert Wickens Thompson, Richmond, VA (US)

(21) Appl. No.: 15/231,748

(22) Filed: Aug. 8, 2016

Related U.S. Application Data
(60) Provisional application No. 62/202,102, filed on Aug. 6, 2015.

(51) Int. Cl. G10G 7/00; A45C 5/02; A45C 13/02; A45C 5/14; A45C 13/10; A45C 13/26

(52) U.S. Cl. CPC G10G 7/005; A45C 13/103; A45C 13/262; A45C 13/02; A45C 5/146; A45C 5/143; A45C 5/02

(57) ABSTRACT

The invention serves to cut the cost of traveling with additional guitars on commercial aircraft in half by guitar style-specific designed soft outer carrying cases which allow the traveler to combine two hard shell guitar traveling cases inside of one single outside soft cover case. Typically, this qualifies the two guitars as “One” piece of luggage, if under 50 lbs., on most domestic and international airlines and therefore the traveler is only charged a fee for “one” additional piece of luggage.

There are no solutions which will combine two acoustic guitars into a one piece baggage item with regards to airline baggage charges. Nor is there any competition which allows the combination of two separate electric guitar cases to be joined together resulting in fewer airline charges for additional luggage.

This invention also makes it easier to maneuver two guitars around at once.

There is configuration zipper 440 which allows the traveler to only expand the case to a single guitar case size for the occasions when only one guitar is being transported.

### BACKGROUND

The invention relates to travelling cases for musical instruments, most notably guitar cases.

### SUMMARY OF INVENTION

The soft outer case serves to reduce the cost of traveling with additional instruments, most notably guitars, on commercial aircrafts generally in half by providing a guitar model-specific designed soft outer cases which allow the traveler to combine two hard shell guitar traveling cases inside of one single soft outer case. Typically, this qualifies the two guitars as “one” piece of luggage, if under 50 lbs., at most domestic and international airlines and therefore the traveler is only charged a fee for “one” additional piece of excess luggage instead of two separate excess pieces.

### DESCRIPTION OF DRAWINGS

FIG. 1 illustrates a standard acoustic guitar hard shell case, which resembles the shape of the guitar itself which is approximately five (5) inches deep, 45 inches long and 19 inches at its widest point for a total of 69 linear inches.

FIG. 2 illustrates a standard shape of an electric guitar hard shell case, which does not resemble that of an electric guitar shape, but rather it resembles that of a rectangle and is approximately three (3) inches deep, 15 inches wide and 48 inches long for a total of 66 linear inches.

FIG. 3 illustrates a hard case is in the shape of the guitar (electric) on one side and flat on the other side, also with a total linear inch count of approximately 66 inches.

FIGS. 4A-D demonstrate the design of the soft outer case of the invention 400 for the acoustic guitar hard shell case (the electric guitar hard shell case example is not shown).

FIG. 4A illustrates the soft outer case in the open position with one guitar.

FIG. 4B illustrates the soft outer case in the open position with two guitars.

FIG. 4C illustrates the soft outer case in the closed position.

FIG. 4D illustrates the bottom of the soft outer case.

### DETAILED DESCRIPTION OF INVENTION

The invention is preferably a manufactured item for traveling on commercial aircraft with musical instruments, most often, acoustic guitars. However, the invention can be used with instruments other than guitars. Airlines charge on average $35 to $200 per extra piece of oversized checked-in baggage up to 50 lbs. For traveling musicians, this makes it more expensive to take more than one instrument with them in order to perform at their best as it becomes expensive when they are on tour, traveling from location to location. Most airlines allow a maximum of 62 linear inches on checked bags and charge Oversized Bag Fees for anything above that limit. Since a single guitar in a hard shell case typically measures between 66 and 70 linear inches, it by itself is in the category of oversized baggage. This invention allows the traveler to double their guitar count to two, by only adding approximately 5-6 linear inches to the total linear inch count. The linear inch length and width remain the same and the additional depth of the second guitar case makes the total between 71 and 76 linear inches, well under the firm maximum of 80 inches.

The invention is a soft outer cover which preferably fits tightly around two guitar hard shell cases that are stacked one on top of the other. In the instance where there are two guitar hard shell cases which are not identical in shape and or size, there are preferably two straps inside the soft outer case which will pull the two hard shell cases together to prevent them from slipping apart.

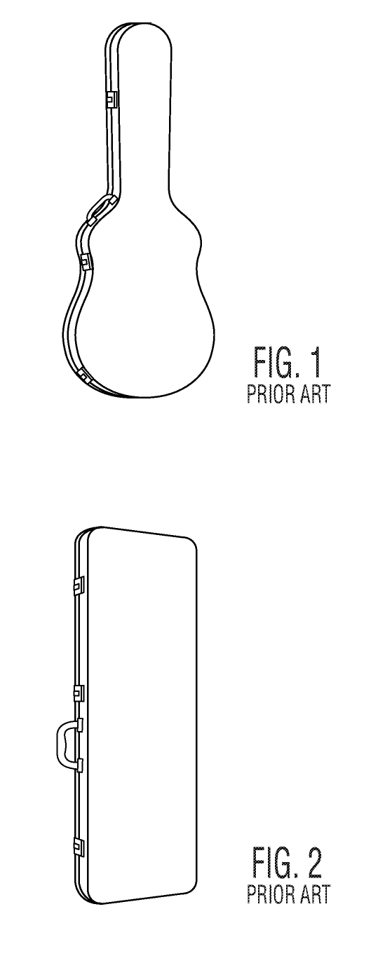

FIGS. 1, 2 and 3 illustrate the three basic guitar hard shell cases.

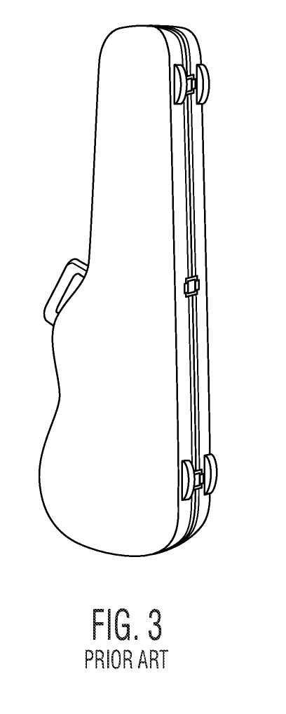

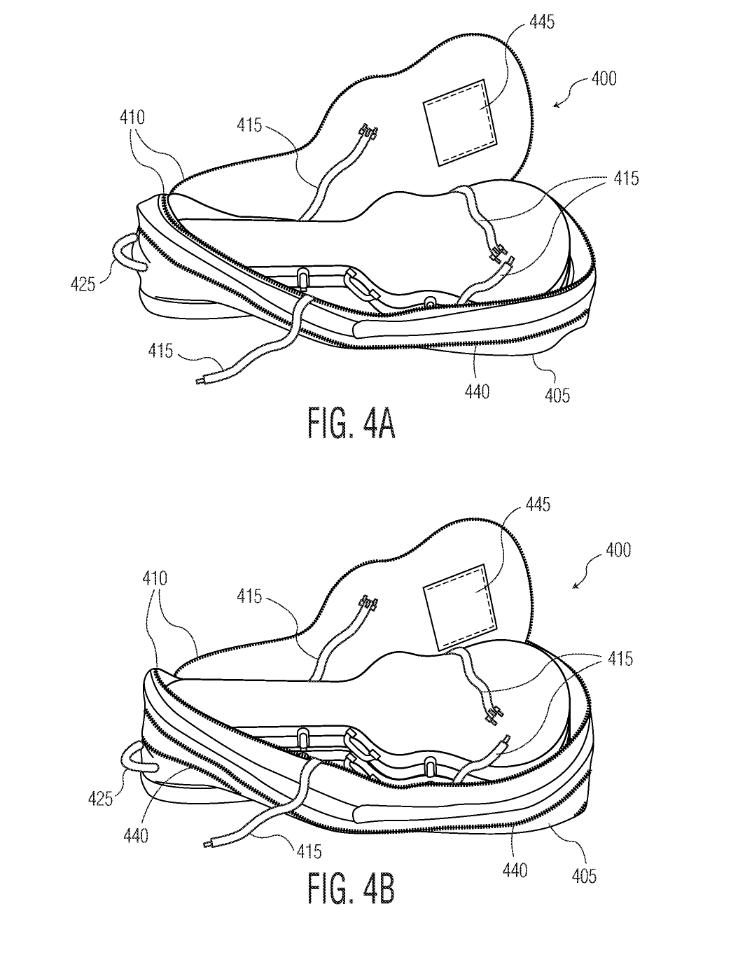

Various embodiments of the soft outer case can accommodate three (3) basic guitar hard shell case designs and sizes (FIGS. 1, 2 & 3). FIG. 1 illustrates a Dreadnaught and/or Jumbo acoustic guitar cases. FIG. 2 illustrates an electric guitar standard case. FIG. 3 illustrates a flat bottom case with a half guitar shape top. The functionality and the method of manufacturing the different shapes of the soft outer case are the same, only the design shape is different in order to accommodate specific guitar type case models.

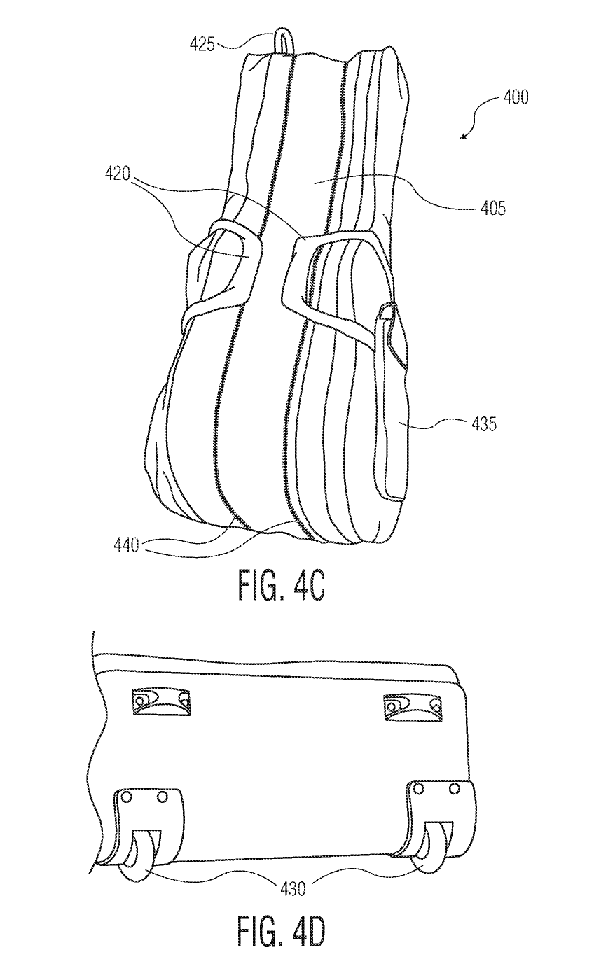

FIGS. 4A-D demonstrate the design of the soft outer case of the invention 400 for the acoustic guitar hard shell case (the electric guitar hard shell case example is not shown).

The components are labelled as:
400—soft outer case
405—soft shell material
410—exterior zipper the length of the soft outer case (to open/close double case);
415—interior stabilizing straps inside to help stabilize the two individual cases within the soft outer case;
420—carrying handles on the outside of the soft outer case;
425—extended carrying handles on top of the soft outer case
430—wheels at the bottom end of the soft outer case for easy transporting;
435—pockets on the outside of the case for additional gear;
440—configuration zipper which allows a slimmer configuration for the soft outer case turning the soft outer case for carrying double cases case into a soft outer case for carrying a single exterior case;
445—inside pockets for the soft outer case.

The invention preferably tightly zips around the stacked guitar hard shell cases and creates one single carrying case. The soft shell material 405 can be made of vinyl, canvas, cotton, plastic, leather, rubber, wool, denim, tweed or any material and combination of materials which are strong enough to hold together two guitar cases weighing over 50 lbs.

The invention also preferably has zipped pockets on the inside 445 and outside 435 for additional guitar gear. The invention also preferably has wheels 430 on the bottom end of the soft outer case 400 in order to easily roll the soft outer case 400 from one point to another by a pulling or pushing, using a handle 425 at the opposite end of the soft outer case 400. These wheels 430 can be made to be detachable or retractable in order to lessen the linear inch total if necessary and they may be stored inside the soft outer case. The invention also preferably has carrying handles/straps 420 in the center on the side in order to be carried in a suitcase fashion. The invention preferably also has a configuration zipper 440 which runs the length of the soft outer case which zips approximately half of the soft outer case inside in order to be able to be used as a single exterior cover for when there is only one guitar case inside which requires additional protection.

The relationship between the components/elements are preferably as follows: the soft outer case 400 includes soft shell material 405, the exterior zipper 410 is to help to tighten and secure the two cases inside the soft outer case (the invention), as are the additional straps inside 415. The inside pocket(s) 445 and the outside pocket(s) 435 are for additional materials to be carried along with the guitar cases. The carrying handles 420 are to carry the soft outer case from one point to another. The wheels 430 at the bottom of the soft outer case 400 allows for easy transporting without carrying the soft outer case by pulling or pushing, using the top handle 425.

The components work individually and together as follows: The oversized soft guitar case 400 holds two hard-shell guitar cases in place. There are three standard shapes of hard-shell guitar cases and each will have its own version of this invention. Other embodiments of the soft outer case will accommodate combinations of the three standard hard-shell guitar cases. For example, one embodiment may accommodate a rectangular electric guitar case and a flat bottom case. In another embodiment, the soft outer case will be configured to accommodate and combination of two of the three standard hard-shell guitar cases. The exterior zipper 410 will hold and secure the hard-shell cases inside the outer shell as well as prevent them from falling out. The stabilizing straps inside 415 the soft outer case 400 will preferably help aid in the securing of the two inner hard-shell cases. The outside pocket(s) 435 and inside pocket(s) 445 are preferably for additional materials and are independent of the utility of the outer case, found on both the inside and outside of the Invention. The carrying handles 420 are preferably for moving the combined hard-shell cases inside the soft outer case from one point to another. The wheels 430 allow for easier transporting so not to have to lift the entire soft outer case up at once to move it.

FIG. 4C shows the soft outer case in a closed position. In this position, the figure illustrates the additional carrying handles 420 on the outside of the case and top handle 425. It also demonstrates the exterior pockets on the invention 435. FIG. 4D illustrates the wheels 430 on the bottom of the soft outer case.

The soft shell material 405 of the soft outer case 400 is made by sewing the soft outer shell of the case (invention) together using either and/or a combination of fabrics and materials including but not limited to canvas, cotton, nylon, plastic and leather, or any other suitable material. The first shape is the standard Dreadnaught and Jumbo acoustic guitar hard shell case shape, whereby the outer case (the invention) shape is measured to tightly fit the exact shape of the guitar case which resemble the shape of an acoustic guitar. The depth of the soft outer case is that of the depth of two standard hard-shell cases sitting one on top of each other in a mirrored position, which is approximately 10 to 12 inches. The soft outer case (the invention) will typically need to be slightly larger in order to fit the two cases inside and to be able to zip it closed. The second style of hard-shell case is that of a standard electric guitar case and is a long rectangular case and approximately half the depth of that of the acoustic guitar cases, creating a total depth of approximately 5 to 6 inches combined. The handles and pockets and wheels, all remain intact to each variation of the design.

Unless defined otherwise, all technical terms used herein have the same meaning as commonly understood by one of ordinary skill in the art to which this invention belongs. Any methods and materials similar or equivalent to those described herein also can be used in the practice or testing of the present disclosure

It must be noted that as used herein and in the appended claims, the singular forms “a”, “and”, and “the” include plural references unless the context clearly dictates otherwise.

While the present disclosure has been described with reference to the specific embodiments and examples thereof, it should be understood by those skilled in the art that various changes may be made and equivalents may be substituted without departing from the true spirit and scope of the invention. In addition, many modifications may be made to adopt a particular situation, material, composition of matter, process, process step or steps, to the objective spirit and scope of the present disclosure. All such modifications are intended to be within the scope of the claims appended hereto. For example and without limitation, the present invention can also be applied to other instruments such as banjos, mandolins, violins, etc.

1. A soft outer case for enclosing and transporting two musical instruments each musical instrument contained in individual hard shell cases, wherein said soft outer case includes:
a soft shell material configured in a way to house said two musical instrument hard shell cases,
an exterior zipper along an outside portion of said soft outer case,
interior stabilizing straps contained within an inside portion of said soft outer case,
a carrying handle on the outside of said soft outer case,
and wheels on a bottom portion of said soft outer case.

2. The soft outer case of claim 1 wherein the soft shell material is made from one of vinyl, canvas, plastic, leather, rubber, cotton, wool, denim, and tweed.

3. The soft outer case of claim 1 wherein a combined linear measurement of said soft outer case is less than or equal to 80 inches.

4. The soft outer case of claim 1 wherein said exterior zipper allows the soft outer case to be opened and closed securely and permits the hard shell cases to be placed into and removed from the soft outer case.

5. The soft outer case of claim 1 further including a configuration zipper in approximately the center (length-way) of the soft outer case wherein when the configuration zipper is closed the interior space of the case is reduced.

6. The soft outer case of claim 1 further including an extended carrying handle.

7. The soft outer case of claim 6 wherein the extended carrying handle is located on the top of said soft outer case and is used to pull or push the soft outer case and the carrying handle is configured as a set of handle grips for carrying the soft outer case like a suitcase, wherein the carrying handle includes straps from both sides of the case in the center.

8. The soft outer case of claim 1 wherein said wheels are retractable.

9. The soft outer case of claim 1 wherein said wheels are removable.

10. The soft outer case of claim 1 wherein the interior stabilizing straps include at least two straps in the interior of the case to help secure the hard shell cases inside.

11. The soft outer case of claim 1 configured to contain two hard shell guitar case designs of a standard acoustic Dreadnaught/Jumbo sizes, a rectangular electric guitar case and a flat bottom case.
